(19) United States
(12) Patent Application Publication
(10) Pub. No.: US 2017/0297369 A1
(43) Pub. Date: Oct. 19, 2017

(54) MOTOR VEHICLE TRAILER, CHASSIS AXLE, IN PARTICULAR FOR A MOTOR VEHICLE TRAILER AND USE OF THE CHASSIS AXLE AND OF A MATERIAL

(71) Applicant: Benteler Steel/Tube GmbH, Paderborn (DE)

(72) Inventors: Marco Walterfang, Paderborn (DE); Jozef Balun, Schlangen (DE); Dirk Westhoff, Paderborn (DE)

(21) Appl. No.: 15/487,700

(22) Filed: Apr. 14, 2017

(30) Foreign Application Priority Data
Apr. 18, 2016 (DE) 10 2016 107 141.2

(51) Int. Cl. B60B 35/04; B62D 63/08; C22C 38/26; C22C 38/06; C22C 38/04; C22C 38/02; C22C 38/34; C21D 9/08; C21D 6/00; C21D 1/18; C22C 38/38; C22C 38/00

(52) U.S. Cl. CPC B60B 35/04; B62D 63/08; B60B 2310/3025; C22C 38/26; C22C 38/06; C22C 38/04; C22C 38/02; C22C 38/001; C21D 9/08; C21D 6/008; C21D 6/005; C21D 6/002; C21D 1/18; B60B 2360/102; C22C 38/38; C22C 38/34

(57) ABSTRACT

The present invention relates to a motor vehicle trailer with at least one rigid axle with at least one tubular element. The motor vehicle trailer is characterized in that the tubular element has a yield strength Rp0.2 of at least 600 MPa, a tensile strength Rm of at least 850 MPa, a breaking elongation A5 of at least 14% and the tubular element (10) consists of an air-hardening, mainly bainitic material. In addition, a chassis axle as well as the use of a material for a chassis axle is disclosed.

### REFERENCE TO PENDING PRIOR PATENT APPLICATION

This patent application claims benefit of German Patent Application No. 10 2016 107 141.2, filed 18 Apr. 2016 by Benteler Steel/Tube GmbH for MOTOR VEHICLE TRAILER, CHASSIS AXLE, IN PARTICULAR FOR A MOTOR VEHICLE TRAILER AND USE OF THE CHASSIS AXLE AND OF A MATERIAL, which patent application is hereby incorporated herein by reference.

### FIELD OF THE INVENTION

Nowadays in the motor vehicle industry the demands with respect to the weight of motor vehicles, as well as trailers for motor vehicles, are increased. It is necessary to keep the weight as low as possible in order to lower the fuel consumption. Nevertheless, the costs should be kept low and in addition the motor vehicles and trailers have to comply with safety requirements.

### BACKGROUND OF THE INVENTION

The invention is based on the finding, that this problem can be solved, by manufacturing one or several axles of the chassis of a motor vehicle or motor vehicle trailer with suitable properties.

### SUMMARY OF THE INVENTION

According to a first aspect, the problem is thus solved by a motor vehicle trailer with at least one chassis axle with at least one tubular element. The motor vehicle trailer is characterized in that the tubular element has a yield strength Rp0.2 of at least 600 MPa, a tensile strength Rm of at least 850 MPa, a breaking elongation A5 of at least 14% and consists of an air-hardening, mainly bainitic material. Preferably, the breaking elongation is at least 16% or the tensile strength is at least 900 MPa. According to one embodiment, the tubular element has a notched bar impact work Av at −20° C. of at least 27 J.

The motor vehicle trailer according to the present invention may be a trailer for a passenger car or for a commercial vehicle. The motor vehicle trailer will hereinafter also be referred to as trailer and the chassis axle of the motor vehicle trailer will be referred to as trailer axle.

The motor vehicle trailer has at least one chassis axle. An axle, via which the connection of the frame to the wheels is established, in the context of the invention is referred to as chassis axle. The chassis axle thus serves for the wheel suspension. The chassis axle comprises a tubular element, which forms the connection between wheels at opposing sides of a motor vehicle and thus at opposing sides of a motor vehicle trailer. The tubular element of the chassis axle is also referred to as axle tube.

In particular, the tubular element has a yield strength Rp0.2 of at least 600 MPa, a yield point or tensile strength Rm of at least 850 MPa, a breaking elongation A5 of at least 14%. Preferably, the breaking elongation is at least 16% or the tensile strength is at least 900 MPa.

Chassis axles, in particular trailer axles, of the present generation, which can also be referred to as traileraxles, are being manufactured with tubular elements, the yield point of which is at 500 MPa or slightly above. The notched bar impact work is >=27 J at −20° C.

In the motor vehicle trailer according to the invention a chassis axle is utilized, the tubular element of which has a yield strength of above 600 MPa and a tensile strength of above 850 MPa and the breaking elongation A5 of which is at least 14%. Thereby, a chassis axle can be utilized which has a tubular element of smaller wall thickness without breaching safety requirements. Thereby, the weight of the chassis axle and thus of the trailer can be lowered but the safety requirements, nevertheless, can be fulfilled. Nevertheless, the chassis axle sustains the challenges, which can occur for example in the motor vehicle trailer at the chassis axle.

In particular, a high force can be absorbed by the chassis axle in particular by the tubular element. In addition, the breaking strength is provided with simultaneous good toughness properties.

The tubular element preferably has a notched bar impact work Av at −20° C. of at least 27 J. The notched bar impact work of the tubular element has been determined by the Charpy notched-bar test. In particular, a specimen with v-shaped notch has been used.

According to the invention, the tubular element of the chassis axle consists of an air-hardening, mainly bainitic material. Thereby, on the one hand the characteristic values, which are demanded by the present invention, can be fulfilled in a simple manner by the structure, i.e. the microstructure, of the material which is mainly bainitic. On the other hand, since the characteristic values can be achieved by cooling by air, the manufacturing of the tubular element and thus of the chassis axle and of the trailer can be simplified. In particular, a complex heat treatment of the tubular element is not necessary.

According to a further aspect, the problem is solved by a chassis axle, in particular for a trailer of a motor vehicle. The chassis axle, however, may also be utilized as a chassis axle of a motor vehicle.

The chassis axle is characterized in that it has at least one tubular element with a yield strength Rp0.2 of at least 600 MPa and a tensile strength Rm of at least 850 MPa and a breaking elongation A5 of at least 14%.

The tubular element is preferably a seamless tube.

In the case of the chassis axle according to the invention, the at least one tubular element consists of an air-hardening, mainly bainitic material.

According to a preferred embodiment, the structure, i.e. the microstructure, of the tubular element of the vehicle axle contains at least 60% bainite, remainder ferrite and/or martensite and/or retained austenite. In particular, the remainder consists of at least 15% ferrite and maximum 10% martensite and/or retained austenite.

In known bainitic materials, which have high yield point and notched bar impact work, it is necessary to form a high content of retained austenite. This content can for example amount to 20%. Examples those steels are CBF (carbide free Bainit)- and TBF (TRIP-aided bainitic ferrite) steels. To achieve the required characteristic values in general a heat treatment, which is expensive, complex and technically difficult to realize, is necessary for these steels, to stabilize the desired amount of retained austenite down to room temperature. This heat treatment requires a complex process control and is difficult to be implemented with process reliability in usual production facilities of plants for manufacturing vehicle components, in particular for tube manufacturing. The characteristic values of the microstructure which is preferably used according to the invention are mainly caused by the bainite portion. Hence, the amount of retained austenite, which is required in the state of the art, is not necessary and the manufacturing of the tubular element for the chassis axle can be simplified and in particular the manufacturing costs can be lowered.

According to a preferred embodiment, the at least one tubular element consists of steel material on iron basis, which comprises the following alloying elements in weight percent:

| | |
|---|---|
| C | 0.06-0.15% |
| Mn | 1.0-3.0% |
| Si | 0.4-2.0% |
| Cr | >0.4% and max. 2.0% |
| Nb | 0.001-0.1% |
| Al | max. 0.25% |
| N | 0.001-0.1% |

In addition, unavoidable impurities can be present in the steel material, which is hereinafter also referred to as material.

According to the invention carbon C is present up to a maximum of 0.15 wt. %. Thereby, the cementite formation FE₃C in the steel material can be kept low and a sufficient toughness of the chassis axle is guaranteed. According to the invention, however, also a carbon content of up to a maximum of 0.13% can be sufficient to achieve these properties.

Silicon Si is added in an amount of at least 0.4 wt. %. It is also possible to add silicon in an amount of at least 0.5 wt. %. By this addition on the one hand a sufficient bainite formation can be achieved and on the other hand silicon also serves for suppressing the FE₃C-formation. Furthermore, the addition of silicon raises the yield point by solid solution formation.

Manganese Mn is added in an amount of at least 1.0 wt. %. Also by these means the through-hardening and the sufficient forming of bainite in the material are guaranteed. Preferably, at least 1.6 wt. % can be provided, whereby the tensile strength and the yield strength can be increased.

The minimal content of nitrogen N of 0.001 wt. % is necessary to enable a niobium carbonitrate forming which is necessary for an increase in toughness by grain refinement.

According to the invention, chromium may also be present in a smaller amount than the indicated lower limit of 0.4 wt. %. The lower limit of chromium can thus for example also be indicated as 0 wt. %. According to a preferred embodiment chromium Cr is added, however, in an amount of more than >0.4 wt. %. Thereby a temper resistance of the material and thus of the tubular element of the chassis axle can be achieved. In addition, the through-hardenability is improved by the addition of chromium. According to a preferred embodiment, chromium, however, is added up to maximum of 2 wt. %. By these means a sufficient notched bar impact work and notch impact strength can be achieved, in particular since the nitride formation or carbide formation can be prevented at these low contents of chromium. In addition, the costs for the material of the tubular element are lower when the chromium content is limited to a maximum of 2 wt. %.

According to a preferred embodiment, the tubular element of the chassis axle is a hot-formed and subsequently air-cooled tubular element. During the manufacturing of the tube or during the hot-forming, respectively, a tube, from which the tubular element is manufactured, is heated to a temperature, which is above the Ac3 temperature of the material. In the preferred embodiment, the tubular element is manufactured without subsequent heat treatment after the hot-forming. It has shown that, nevertheless, the properties according to the invention of the tubular element can be adjusted.

According to an embodiment, the tubular element is manufactured in such a way that during hot-forming a mean austenite grain size of less than 50 μm is formed. Subsequently, the tubular element is cooled by air. The cooling may take place in moving air or in still air. In particular, the cooling is performed such that the temperature range between 800° C. and 500° C. is passed through at a cooling rate of 0.1 to 0.8° C./s.

Thereby, a fine grained and uniform structure can be achieved, the strength and toughness properties of which are further improved.

According to one embodiment, the chassis axle is a friction welded chassis axle, wherein the tubular element is connected with at least one journal by friction welding. The journal may also be referred to as axle-end pivot or pin. Such an embodiment is possible according to the present invention, since also after attaching, for example the welding of the journals, the characteristic values still are given in the tubular element.

The chassis axle according to a preferred embodiment is a rigid axle. The type of wheel suspension, wherein the wheels of one axle are connected to each other via a rigid axle body, in particular the tubular element, is referred to as rigid axle.

The chassis axle may be an axle of the motor vehicle. Also there, the chassis axle preferably is a rigid axle. It is particularly preferred that the chassis axle is a motor vehicle trailer axle. These axles, which generally are formed as rigid axles, are subjected to tension and/or compression loads, but in particular bending and torsion loads. With the properties of the chassis axle according to the invention, it can sustain this stress and the safety is thus guaranteed.

In addition or alternatively, the chassis axle may comprise joints or other attachment parts for wheel connection and/or a steering rod or can be formed as a twist beam axle.

The present invention thus also relates to the use of a chassis axle according to the invention in a motor vehicle and preferably in a motor vehicle trailer.

The chassis axle according to the invention is characterized by an improved surface quality, whereby the coating of the chassis axle becomes possible. The chassis axle according to the invention may therefore be coated. Thereby, the corrosion resistance of the chassis axle is improved. In addition, the chassis axle can also be protected against mechanical damage, for example stone chipping. The coating may for example be zinc plating, plastic coating, varnish or the like.

According to a further aspect, the problem is solved by the use of a material for manufacturing a tubular element of a chassis axle for a motor vehicle or a motor vehicle trailer. The material is characterized in that the material is a steel material on iron basis, which comprises the following alloying elements in weight percent:

| | |
|---|---|
| C | 0.06-0.15% |
| Mn | 1.0-3.0% |
| Si | 0.4-2.0% |
| Cr | >0.4% and max. 2.0% |
| Nb | 0.001-0.1% |
| Al | max. 0.25% |
| N | 0.001-0.1%. |

The advantages of these alloying elements in the material which is used according to the invention have already been described above.

In addition, it should be noted that the material which is used according to the invention is an inexpensive material due to the mandatorily contained alloying elements, which are comparatively inexpensive. With the material which is used according to the invention, nevertheless the inventive properties of the tubular element and the chassis axle can be adjusted reliably.

According to a further embodiment, the steel material in addition comprises at least one of the following alloying elements: vanadium, titanium, boron, nickel, molybdenum. If present, these alloying elements are preferably present in the following amounts in weight percent:

| | | |
|---|---|---|
| V | max. | 0.15 |
| Ti | max. | 0.1 |
| B | max. | 0.005 |
| Ni | max. | 2.0 |
| Mo | max. | 0.5. |

According to a preferred embodiment, the aluminum content is at least 0.05 wt. %. With this aluminum content the bainitic transformation can be supported. If the aluminum content is below this content, it may occur that the bainitic transformation takes place to slowly and that thus the preferably yielded bainite content may not be achieved in a simple manner.

One example of a composition of the material which is used according to the invention is a material which, besides iron and unavoidable impurities, contains the following alloying elements in the indicated amounts in wt. %:

| | |
|---|---|
| C | 0.08 |
| Mn | 2.28 |
| Si | 0.72 |
| Cr | 1.2 |
| Nb | 0.03 |
| Al | 0.03 |
| N | 0.008. |

With such material, the following characteristic values were achieved: Rp0.2>=600 MPa, Rm>=900 MPa, A5>16% %, Av (−20° C.)>=27 J, condition: +AR (as rolled).

While aluminium is an optional element of the material, the further alloying elements of the inventive material are mandatory components of the material, in order to achieve the desired properties.

According to a preferred embodiment, the content of niobium in the material which is used according to the invention is at least 0.01 wt. %. By this addition of niobium, a good grain refinement in the material can be achieved and the properties according to the invention can thus be achieved reliably.

The material may have as optional alloying elements at least of the following elements: vanadium, titanium, boron, nickel, molybdenum and aluminium. These alloying elements, however, are not mandatory to achieve the inventive properties of the tubular element and thus of the chassis axle. Hence, the costs of the material can be kept at a low level.

Advantages and features, which are described with respect to the motor vehicle trailer, the chassis axle or the use—as far as applicable—also relate to the respective other subject and are thus potentially only described once.

### BRIEF DESCRIPTION OF THE DRAWINGS

Hereinafter three embodiments of the chassis axle are described with the aid of the attached figures.

FIG. 1: shows a schematic depiction of the assembly of a chassis axle according to the invention,

FIG. 2: shows a second embodiment of the present invention,

FIG. 3: shows a third embodiment of the present invention,

FIG. 4: shows a trailer with chassis axle according to the invention.

### DETAILED DESCRIPTION OF THE PREFERRED EMBODIMENT

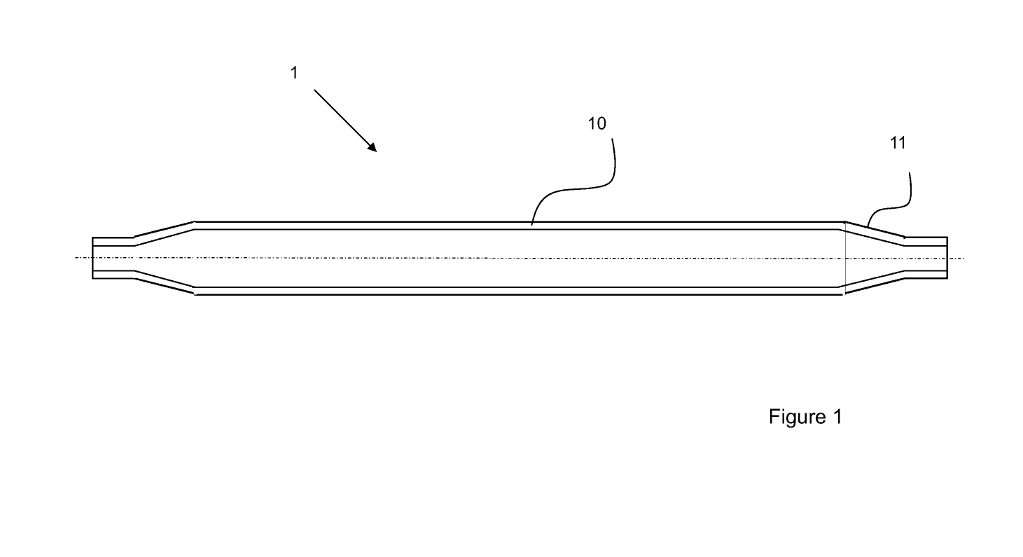

In FIG. 1 a first embodiment of a chassis axle 1 is schematically shown. In the depicted embodiment, the chassis axle 1 has a tubular element 10, which can also be referred to as an axle tube. The tubular element 10 is preferably a seamless tubular element 10. At each of both ends of the tubular element 10, a journal 11 is provided respectively. The journals 11 are arranged at the ends of the tubular element 10. In the embodiment according to FIG. 1, the journals 11 are formed by mechanical working of the ends of the tubular element 10 itself, in particular by hot-forming. The journals 11 may for example be drawn-in or rotary swaged ends of the tubular element 10.

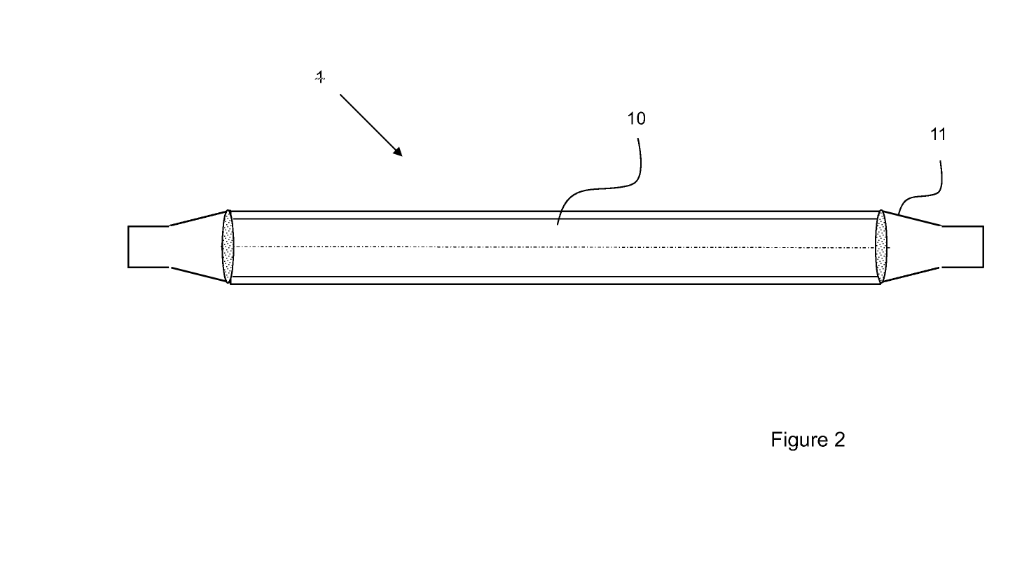

In FIG. 2 a second embodiment of the chassis axle 1 is schematically shown. In the depicted embodiment, the chassis axle 1 has a tubular element 10, which can also be referred to as axle tube. The tubular element 10 is preferably a seamless tube 10. On each of both ends of the tubular element 10 a journal 11 is provided respectively. The journals 11 are arranged at the ends of the tubular element 10. The journals 11 may for example be connected to the tubular element 10 by material closure, in particular friction welding. In the embodiment shown in FIG. 2, the journals 11 are forged journals 11, which are connected to the ends of the tubular element 10 by material closure, for example by friction welding.

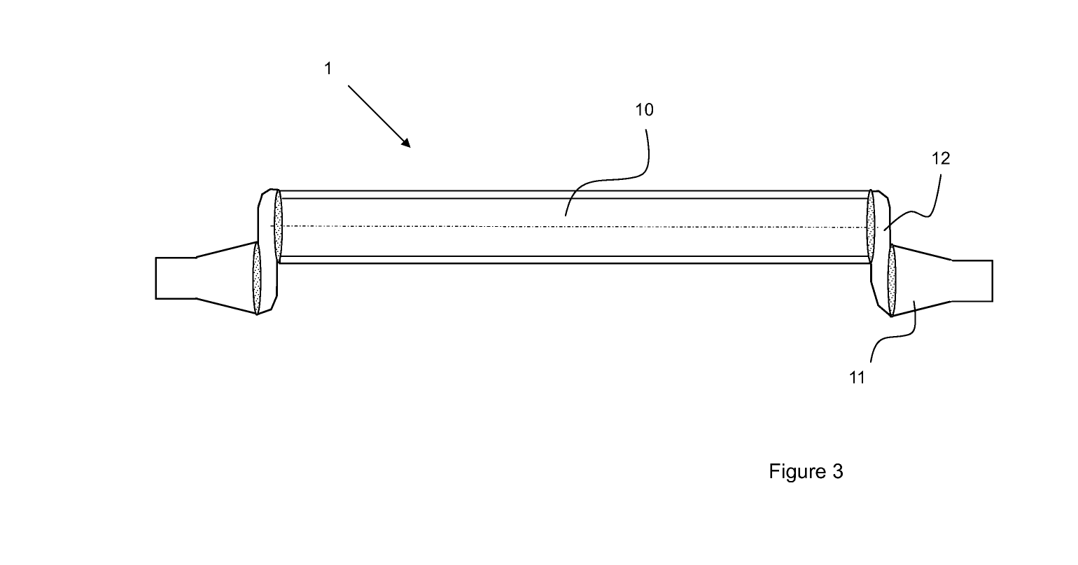

In FIG. 3 a further embodiment of a chassis axle 1 is shown. Also in this embodiment, the chassis axle 1 has a tubular element 10 and at its ends journals 11 are attached. In the embodiment shown in FIG. 3, the journals 11 are connected via connection pieces 12 with the ends of the tubular element and are in particular welded thereto.

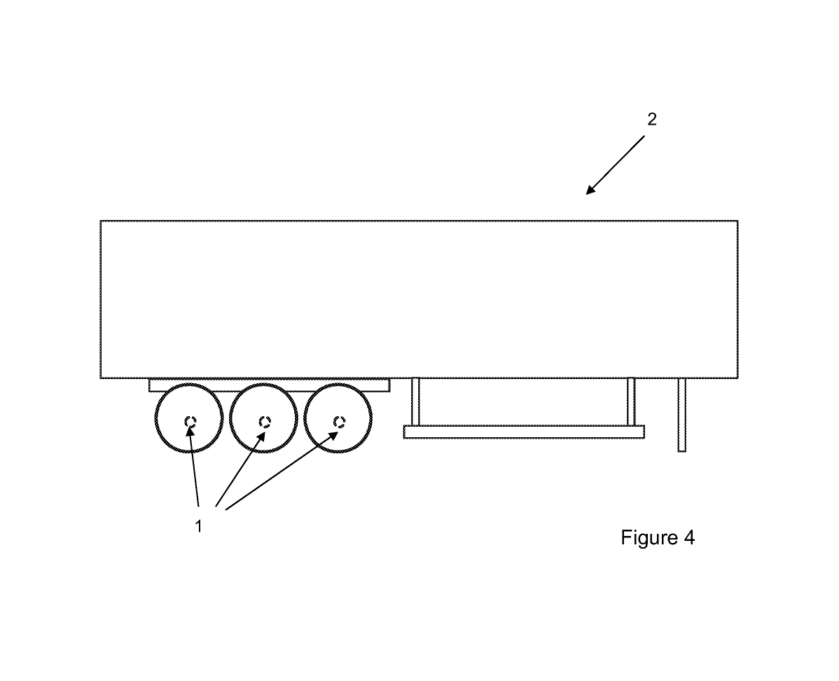

In FIG. 4 an embodiment of a trailer 2 according to the invention is shown. In the depicted embodiment, the trailer 2 has three chassis axles 1. These are designed according to the invention and can for example have one of the designs of the chassis axle 1 as shown in FIGS. 1 to 3.

With the present invention in particular an inexpensive material is disclosed, which has a yield strength of >=600 MPa and a notched bar impact work of >=27 J at −20° C. and which is suitable for manufacturing seamless tubes without subsequent heat treatment.

The invention has a number of advantages. Firstly, light weight construction potential is given with the present invention, which can for example be used for vehicle trailers or trailer axles. In particular, the wall thickness of the tubular element can be reduced due to the considerably higher yield strength (>=600 MPa) and thereby the weight of the chassis axle can be reduced. Furthermore, the low yield point ratio of for example 0.6-0.7 guarantees a good formability of the material and thus a simple manufacture of the chassis axle.

The material which is used according to the invention is a high-strength bainitic material, with mainly bainitic structure, with which a good toughness even without subsequent heat treatment can be achieved. Values of Rp0,2>=600 MPa, Rm>=850 MPa, A5>=14% are achieved. The delivery condition therein may be +AR (as rolled). The notched bar impact work may for example be >=27 J at −20° C.

### Modifications Of The Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

### REFERENCE NUMBERS

1 chassis axle
10 tubular element
11 journal
12 connection piece
2 trailer

1. Motor vehicle trailer with at least one chassis axle with at least one tubular element, characterized in that the tubular element has a yield strength Rp0.2 of at least 600 MPa, a tensile strength Rm of at least 850 MPa and a breaking elongation A5 of at least 14% and consists of an air-hardening, mainly bainitic material.

2. Motor vehicle trailer according to claim 1, characterized in that the tubular element has a notched bar impact work Av at −20° C. of at least 27 J.

3. Chassis axle, in particular for a trailer of a motor vehicle, characterized in that the chassis axle has at least one tubular element with a yield strength Rp0.2 of at least 600 MPa, a tensile strength Rm of at least 850 MPa and a breaking elongation A5 of at least 14% and the tubular element consists of an air-hardening, mainly bainitic material.

4. Chassis axle according to claim 3, characterized in that the at least one tubular element has a structure, which consists of at least 60% bainite, with the remainder comprising at least one from the group consisting of ferrite, martensite, and retained austenite.

5. Chassis axle according to claim 3, characterized in that the at least one tubular element consists of a steel material on iron basis, which comprises the following alloying elements in weight percent:

| | |
|---|---|
| C | 0.06-0.15% |
| Mn | 1.0-3.0% |
| Si | 0.4-2.0% |
| Cr | >0.4% and max. 2.0% |
| Nb | 0.001-0.1% |
| Al | max. 0.25% |
| N | 0.001-0.1%. |

6. Chassis axle according to claim 3, characterized in that the tubular element has a notched bar impact work Av at −20° C. of at least 27 J.

7. Chassis axle according to claim 3, characterized in that the tubular element is a hot-formed, in particular seamless, and subsequently air-cooled tubular element.

8. Chassis axle according to claim 3, characterized in that the chassis axle is a friction welded chassis axle, wherein the tubular element is connected to at least one journal by means of friction welding.

9. Chassis axle according to claim 3, characterized in that the chassis axle is a rigid axle.

10. Use of the chassis axle according to claim 3 in a motor vehicle trailer, wherein the motor vehicle trailer comprises at least one chassis axle with at least one tubular element, characterized in that the tubular element has a yield strength Rp0.2 of at least 600 MPa, a tensile strength Rm of at least 850 MPa and a breaking elongation A5 of at least 14% and consists of an air-hardening, mainly bainitic material.

11. Use of a material for manufacturing a tubular element of a chassis axle for a motor vehicle or a motor vehicle trailer, characterized in that the material is a steel material on iron basis, which comprises the following alloying elements in weight percent:

| | |
|---|---|
| C | 0.06-0.15% |
| Mn | 1.0-3.0% |
| Si | 0.4-2.0% |
| Cr | >0.4% and max. 2.0% |
| Nb | 0.001-0.1% |
| Al | max. 0.25% |
| N | 0.001-0.1%. |

12. Use according to claim 11, characterized in that the content of niobium is at least 0.01 wt. %.

13. Use according to claim 11, characterized in that as optional alloying elements at least one of the following elements is contained: vanadium, titanium, boron, nickel, molybdenum and aluminium.

14. Use according to claim 11, characterized in that the tubular element is a tubular element of a chassis axle for a motor vehicle or a motor vehicle trailer, characterized in that the chassis axle has at least one tubular element with a yield strength Rp0.2 of at least 600 MPa, a tensile strength Rm of at least 850 MPa and a breaking elongation A5 of at least 14% and the tubular element consists of an air-hardening, mainly bainitic material.

15. Use of a chassis axle for a trailer of a motor vehicle, characterized in that the chassis axle has at least one tubular element with a yield strength Rp0.2 of at least 600 MPa, a tensile strength Rm of at least 850 MPa and a breaking elongation A5 of at least 14% and the tubular element consists of an air-hardening, mainly bainitic material in a motor vehicle according to claim 1.
